(19) United States
(12) Patent Application Publication
(10) Pub. No.: US 2026/0313234 A1
(43) Pub. Date: Oct. 8, 2026

(54) IMAGING APPARATUS

(71) Applicant: Panasonic Intellectual Property Management Co., Ltd., Osaka (JP)

(72) Inventor: Yoshihide NAGATA, Osaka (JP)

(73) Assignee: Panasonic Intellectual Property Management Co., Ltd., Osaka (JP)

(21) Appl. No.: 19/632,357

(22) Filed: Mar. 29, 2026

(30) Foreign Application Priority Data
Apr. 2, 2025 (JP) 2025-061198

(51) Int. Cl. H04N 23/68; H04N 25/47

(52) U.S. Cl. CPC H04N 23/683; H04N 23/6811; H04N 25/47

(57) ABSTRACT

An imaging apparatus includes: an image sensor that captures a subject image at a first cycle via a first optical system to generate imaging data; a detector that outputs detection data via a second optical system, the detection data indicating a detection result of a change in the subject image at a second cycle shorter than the first cycle; and a controller that controls an image capturing operation using the image sensor and the detector, wherein the controller limits an output of the detection data by the detector when the second optical system is driven in the image capturing operation.

### TECHNICAL FIELD

The present disclosure relates to an imaging apparatus that uses a plurality of sensors for image capturing.

### BACKGROUND ART

WO 2024/004519 A1 discloses an imaging apparatus including a first sensor such as an image sensor and a second sensor such as an event-based vision sensor (EVS). The imaging apparatus reconstructs a plurality of event images from event data acquired by the EVS, specifies movement of a subject on the basis of the plurality of event images, and corrects a blur occurring in image data acquired by the image sensor. The imaging apparatus also obtains an optical flow of each region in the image data using a plurality of event images, and interpolates image data between frames. The object of WO 2024/004519 A1 is to suppress a reduction in transfer efficiency in such an imaging apparatus.

### SUMMARY

The present disclosure provides an imaging apparatus capable of facilitating image capturing using a plurality of sensors.

An imaging apparatus according to an aspect of the present disclosure includes: an image sensor that captures a subject image at a first cycle via a first optical system to generate imaging data; a detector that outputs detection data via a second optical system, the detection data indicating a detection result of a change in the subject image at a second cycle shorter than the first cycle; and a controller that controls an image capturing operation using the image sensor and the detector, wherein the controller limits an output of the detection data by the detector when the second optical system is driven in the image capturing operation.

An imaging apparatus according to another aspect of the present disclosure includes: an image sensor that captures a subject image at a first cycle via a first optical system to generate imaging data; a detector that outputs detection data via a second optical system configured separately from the first optical system, the detection data indicating a detection result of a change in the subject image at a second period shorter than the first period; a controller that controls an image capturing operation using the image sensor and the detector, wherein the controller drives the second optical system when the first optical system is driven in accordance with an instruction to drive the first optical system.

According to the imaging apparatus of the present disclosure, it is possible to facilitate image capturing using a plurality of sensors.

### BRIEF DESCRIPTION OF THE DRAWINGS

FIG. 1 is a block diagram showing a configuration of a digital camera according to a first embodiment of the present disclosure;

FIG. 2 is a diagram illustrating a circuit configuration of a pixel of an event sensor in the digital camera;

FIGS. 3A-3C are diagrams for explaining an overview of the operation of the digital camera according to the first embodiment;

FIGS. 4A-4H are timing charts illustrating an operation of the digital camera in the first embodiment;

FIG. 5 is a flowchart illustrating event control processing in the digital camera of the first embodiment;

FIG. 6 is a flowchart illustrating event image correction processing in digital camera;

FIG. 7 is a block diagram showing a configuration of a digital camera according to a second embodiment;

FIG. 8 is a flowchart illustrating event control processing in the digital camera of the second embodiment;

FIG. 9 is a block diagram showing a first modification of the configuration of the digital camera;

FIG. 10 is a block diagram showing a second modification of the configuration of the digital camera; and

FIGS. 11A-11H are timing charts showing a modification of the operation of the digital camera.

### DETAILED DESCRIPTION

Hereinafter, embodiments will be described in detail with reference to the drawings as appropriate. However, unnecessarily detailed description may be omitted. The accompanying drawings and the following description are provided for those skilled in the art to fully understand the present disclosure, and are not intended to limit the subject matter described in the appended claims.

### First Embodiment

Hereinafter, a configuration and an operation of a digital camera which is an embodiment of an imaging apparatus according to the present disclosure will be described.

### 1. Configuration

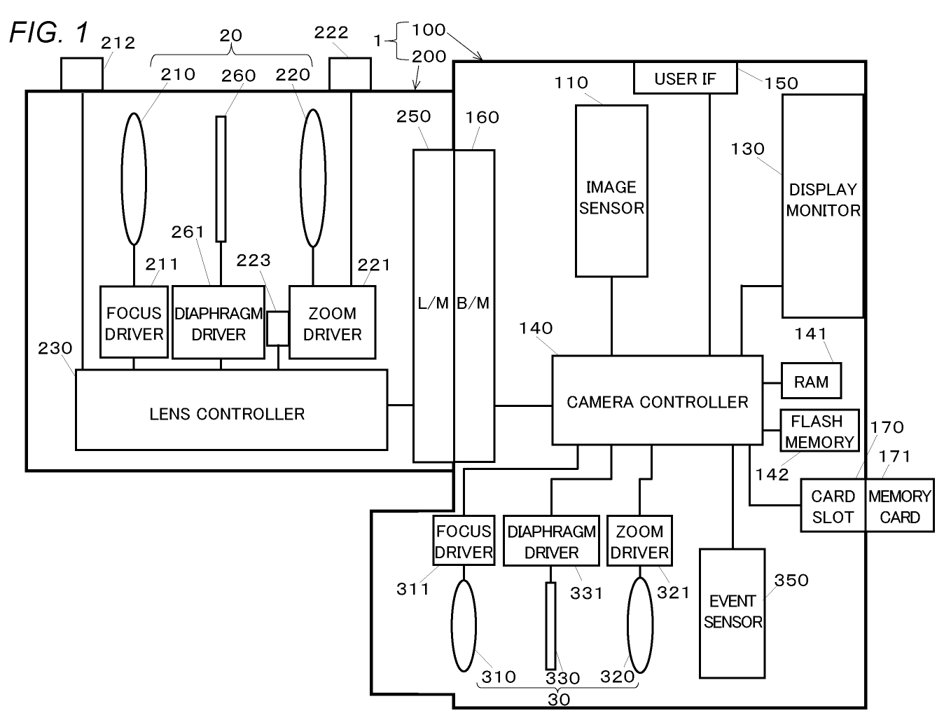

FIG. 1 is a block diagram showing a configuration of a digital camera 1 according to a first embodiment. The digital camera 1 of the present embodiment is constituted by a camera body 100 and an interchangeable lens 200 that is attachable to and detachable from the camera body 100.

### 1.1 Camera Body

The camera body 100 (an example of an imaging apparatus) includes an image sensor 110, a display monitor 130, a user interface 150, a camera controller 140, a RAM 141, a flash memory 142, a body mount 160, and a card slot 170.

The image sensor 110 is a device that captures a subject image incident through the interchangeable lens 200 and generates image data (also referred to as captured image data). For example, the image sensor 110 is a CMOS image sensor. The generated image data is subjected to predetermined image processing by the camera controller 140. For example, the predetermined image processing is gamma correction processing, white balance correction processing, flaw correction processing, YC conversion processing, electronic zoom processing, and JPEG compression processing. The image sensor 110 may be a CCD or NMOS image sensor, or the like.

The image sensor 110 operates at a timing controlled by the camera controller 140, for example. The image sensor 110 generates a still image or a moving image for recording, or a live view image. The live view image is an example of a moving image displayed on the display monitor 130 to visualize a real-time imaging result by the image sensor 110 to the user.

The display monitor 130 is an example of a display that displays an image such as a live view image and various kinds of information such as a menu screen on a display screen. The display monitor 130 can be configured by various display devices such as a liquid crystal display device or an organic EL device. In addition to or instead of the display monitor 130, the digital camera 1 may include, for example, an electronic viewfinder (EVF) having a display screen as an example of another display in the camera body 100.

The user interface 150 is a general term for user interfaces that allow a user to input an operation (instruction). When the user interface 150 receives an input of a user operation, the user interface 150 transmits an operation signal indicating various instructions according to the user operation to the camera controller 140. For example, the user interface 150 includes a physical button, a lever, a dial, a touch panel, a switch, and the like. The user interface 150 may also include virtual buttons and icons displayed on the display monitor 130.

The camera controller 140 controls the overall operation of the digital camera 1 by controlling the components such as the image sensor 110 in accordance with an instruction from the user interface 150. The camera controller 140 may be configured by a hard-wired electronic circuit such as an image signal processor (ISP), or may be configured by a microcomputer that executes a program. The camera controller 140 may include a timing generator.

For example, the camera controller 140 transmits a vertical synchronization signal to the image sensor 110. In parallel with this, the camera controller 140 generates a synchronization signal synchronized with the vertical synchronization signal, and transmits the synchronization signal to the lens controller 230 via the body mount 160 and the lens mount 250. The camera controller 140 uses the RAM 141 as a work memory during a control operation or an image processing operation.

The flash memory 142 stores programs and parameters used when the camera controller 140 performs control.

The body mount 160 can be mechanically and electrically connected to lens mount 250 of interchangeable lens 200. The body mount 160 can transmit and receive data to and from the interchangeable lens 200 via the lens mount 250. The body mount 160 transmits the exposure synchronizing signal received from the camera controller 140 to the lens controller 230 via the lens mount 250.

The body mount 160 also transmits other control signals received from the camera controller 140 to the lens controller 230 via the lens mount 250. The body mount 160 also transmits a signal received from the lens controller 230 via the lens mount 250 to the camera controller 140.

The card slot 170 can be mounted with the memory card 171, and controls the memory card 171 based on the control from the camera controller 140. The digital camera 1 can store image data in the memory card 171 and read image data from the memory card 171.

### 1.2 Interchangeable Lens

As shown in FIG. 1, the interchangeable lens 200 includes an imaging optical system 20 including a focus lens 210, a zoom lens 220, and a diaphragm 260, for example. The imaging optical system 20 is an example of a first optical system in the present embodiment. The interchangeable lens 200 further includes various drivers 211, 221, 261, a lens controller 230, and a lens mount 250. The interchangeable lens 200 may further include an image stabilizer lens in addition to the lenses shown in FIG. 1. The imaging optical system 20 may include various drivers 211, 221, 261 in the interchangeable lens 200.

The interchangeable lens 200 further includes operation members such as a focus ring 212 and a zoom ring 222. The operation member of the interchangeable lens 200 is not limited thereto, and may include a button provided on the exterior, for example.

The lens controller 230 controls the overall operation of the interchangeable lens 200. The lens controller 230 may be configured by a hard-wired electronic circuit, or may be configured by a microcomputer that executes a program, or the like. The lens controller 230 may include a RAM, a ROM, a flash memory, or the like. The RAM functions as a work memory used by the lens controller 230 during control. The ROM or the flash memory stores programs, parameters, lens data, and the like used for control of the lens controller 230.

The zoom lens 220 is a lens for changing the magnification of a subject image formed by the optical system of the interchangeable lens 200. The zoom lens 220 may have any number of lenses or any number of groups of lenses. The zoom driver 221 is a mechanical mechanism that moves the zoom lens 220 along the optical axis of the optical system based on the operation of the zoom ring 222 by the user. The position of the zoom lens 220 is detected by a zoom lens position detector 223 as needed, and is notified to the lens controller 230.

The zoom ring 222 has a predetermined angle range (e.g., 90 degrees) in which the optical focal length of the zoom lens 220 in the interchangeable lens 200 is movable between a wide angle end at which the optical focal length is the shortest and a telephoto end at which the optical focal length is the longest. The zoom ring 222 is an example of an operation member that can perform a zoom operation by being operated to various rotation angles within the angle range.

The focus lens 210 is a lens for changing a focus state of a subject image that is incident from the optical system and formed on the image sensor 110. The focus lens 210 may have any number of lenses or any number of groups of lenses. The focus driver 211 drives the focus lens 210 to advance and retract along the optical axis of the optical system based on the control of the lens controller 230. The focus driver 211 can be implemented by a stepping motor, a DC motor, an ultrasonic motor, or the like, for example.

The diaphragm 260 adjusts the amount of light incident on the image sensor 110. The diaphragm 260 is driven by a diaphragm driver 262, and the size of the aperture thereof is controlled. The diaphragm driver 262 includes a motor or an actuator. The interchangeable lens 200 may include an aperture ring or the like that receives a user operation for adjusting the aperture value of the diaphragm 260.

### 1.3 Event Sensor

In the present embodiment, for example, the camera body 100 of the digital camera 1 further includes an event sensor 350, an event optical system 30, and various drivers 311, 321, 331, as illustrated in FIG. 1.

The event sensor 350 is an optical sensor such as an EVS, and includes a plurality of pixels that each detect a change in luminance in a range to be detected, that is, an angle of view range. In the event sensor 350, a plurality of pixels are arranged in a two-dimension array to form a light receiving surface.

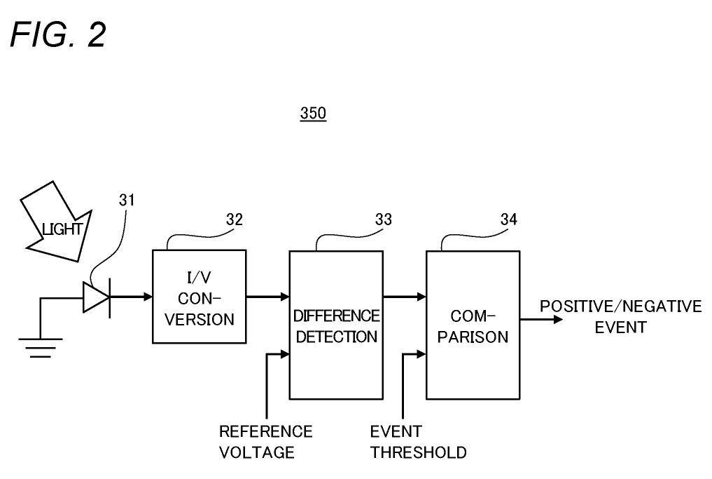

FIG. 2 illustrates a circuit configuration of a pixel of the event sensor 350. As illustrated in FIG. 2, the pixel of the event sensor 350 includes, for example, a light receiving element 31, an I/V conversion circuit 32, a difference detection circuit 33, and a comparison circuit 34.

For example, the light receiving element 31 is a photodiode, and receives light from the outside to generate a photocurrent according to the amount of received light. The I/V conversion circuit 32 converts the photocurrent from the light receiving element 31 into a light reception voltage corresponding to the amount of received light.

The difference detection circuit 33 detects a difference between the light reception voltage from the I/V conversion circuit 32 and the reference voltage, and outputs a signal indicating the detected difference value to the comparison circuit 34. For example, such a reference voltage is in turn set to the light reception voltage when an event is finally detected from the pixel of the event sensor 350. For example, the difference value has a positive sign corresponding to an increase in the amount of received light or a negative sign corresponding to a decrease in the amount of received light.

The comparison circuit 34 compares the difference value indicated by the signal from the difference detection circuit 33 with a predetermined event threshold value, and determines whether or not to detect a positive event in which the luminance increases or a negative event in which the luminance decreases. For example, the event threshold value is set by the camera controller 140 as a reference of a luminance change detected as a positive or negative event.

For example, the comparison circuit 34 determines that a positive event is detected when the difference value has a positive sign and its magnitude (i.e., absolute value) exceeds the event threshold, and determines that a negative event is detected when the difference value has a negative sign and its magnitude exceeds the event threshold. The comparison circuit 34 determines that no event is detected when the magnitude of the difference value does not exceed the event threshold. For example, the comparison circuit 34 generates a detection signal indicating a timing at which a positive or negative event is detected.

When the positive or negative event is detected based on the detection signal of the comparison circuit 34 of each pixel, the event sensor 350 generates event data indicating the two-dimension coordinates of the pixel on the light receiving surface, the detection timing, and the positive or negative of the event in association with each other. The event sensor 350 in turn outputs event data to the camera controller 140 at a predetermined operation cycle (e.g., several microseconds). The event sensor 350 is an example of a detector in the present embodiment.

Referring back to FIG. 1, the event optical system 30 is an optical system that guides light from the outside so that an image is formed on a light receiving surface of the event sensor 350. For example, the event optical system 30 includes a focus lens 310 that adjusts a focus position of an image formed on the event sensor 350, a zoom lens 320 that adjusts an angle of view range, and a diaphragm 330 that adjusts a diaphragm value. Each lens 310, 320 may be any number of lens elements or any number of lens groups.

In the present embodiment, the event optical system 30 is fixedly built in the digital camera 1. The event optical system 30 has a lens outer diameter smaller than the lens outer diameter of the imaging optical system 20 in the interchangeable lens 200, for example. The event optical system 30 is an example of a second optical system in the present embodiment.

The various drivers 311 to 331 include a focus driver 311 for the focus lens 310, a zoom driver 321 for the zoom lens 320, and a diaphragm driver 331 for the diaphragm 330. For example, the drivers 311 to 331 are each formed of various motors or actuators, and drive the corresponding optical elements 310 to 330 in the event optical system 30 in accordance with an instruction from the camera controller 140. The event optical system 30 may include various drivers 311 to 331.

### 2. Operation

The operation of the digital camera 1 configured as described above will be described below.

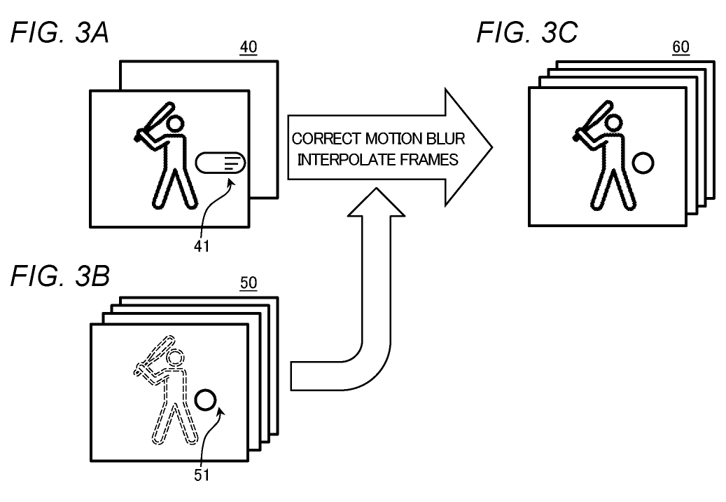

FIGS. 3A to 3C are diagrams for explaining an outline of the operation of the digital camera 1 according to the present embodiment. The digital camera 1 of the present embodiment captures a moving image at a frame rate higher than the frame rate of the image capturing operation of the image sensor 110 by interpolating frames by the image sensor 110 using the event sensor 350, for example. For example, the imaging frame rate is 30 to 60 fps (frames per second), and the moving image frame rate is 120 to 1200 fps.

FIG. 3A illustrates a captured image 40 by the image sensor 110 of the digital camera 1. In the digital camera 1, the captured image 40 by the image sensor 110 is obtained for each frame of the imaging frame rate at a high resolution (i.e., spatial resolution) such as 4K. The captured image 40 illustrated in FIG. 3A includes a blurred portion 41 due to the movement of the subject. Such a blurred portion 41 of the captured image 40 may occur due to the relatively low time resolution of the image sensor 110.

FIG. 3B illustrates an event image 50 by the event sensor 350 of the digital camera 1. The event image 50 is an image indicating a detection result by the event sensor 350, and is generated as intermediate data at a moving image frame rate, for example. According to the event sensor 350, as illustrated in FIG. 3B, a portion 51 of a luminance change corresponding to the blur portion 41 of the captured image 40 (FIG. 3A) can be clearly imaged in the event image 50 with a higher time resolution than the image sensor 110, for example. On the other hand, the resolution of the event image 50 may be lower than that of the captured image 40, and may be FHD or HD, for example.

FIG. 3C illustrates a corrected image 60 in the digital camera 1 of the present embodiment. For example, the digital camera 1 of the present embodiment performs image processing of combining the corrected image 60 obtained by correcting the captured image 40 for each event image 50, to generate moving image data of the corrected image 60 as illustrated in FIG. 3C. The corrected image 60 is synthesized so that the blurred portion 41 in the captured image 40 is replaced with the luminance changed portion 51 by the event image 50, for example. By such a synthesis processing, it is possible to suppress the motion blur of the subject in the corrected image 60.

FIG. 3B illustrates the event image 50 in which the parallax with respect to the captured image 40 has been corrected. In the digital camera 1, parallax in which the positions of the subject images are shifted between the captured image 40 and the event image 50 may occur due to a difference in the arrangement of the imaging optical system 20 and the event optical system 30. In the digital camera 1 of the present embodiment, the synthesis processing of the corrected image 60 (FIG. 3C) is performed based on the stereo matching for correcting such parallax.

For example, the digital camera 1 of the present embodiment drives the imaging optical system 20 and the event optical system 30 in synchronization with each other at the time of moving image capturing using the event sensor 350 as described above. Accordingly, the digital camera 1 of the present embodiment can reduce the difference between the captured image 40 and the event image 50 in the imaging state other than the parallax of each optical system 20, 30, and can easily combine the corrected image 60 based on the stereo matching.

In the digital camera 1 of the present embodiment, when the event optical system 30 is driven, the detection operation of the event sensor 350 is limited so that the event sensor 350 is intentionally made to hardly detect an event, for example. Accordingly, the digital camera 1 of the present embodiment can make it difficult for the luminance change due to the driving of the event optical system 30 not caused by the motion blur of the subject to be included in the event image 50, and can make it easy to correct the motion blur of the subject in the synthesis processing of the corrected image 60.

Hereinafter, the operation of the digital camera 1 according to the present embodiment will be described in detail.

### 2.1 Moving Image Capturing Operation

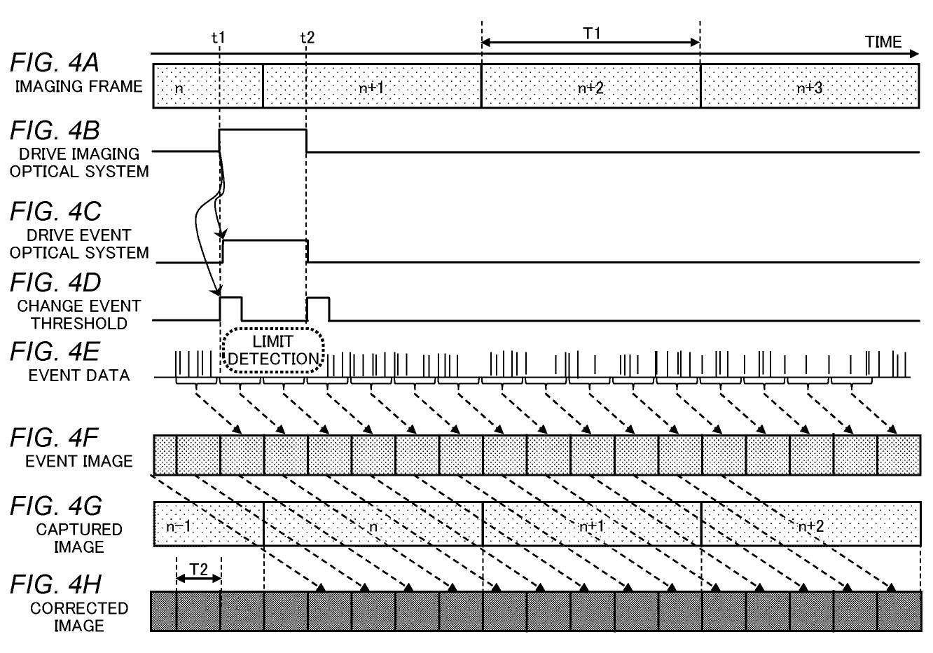

The moving image capturing operation of the digital camera 1 according to the present embodiment will be described in detail with reference to FIGS. 4A-4H. FIGS. 4A-4H are timing charts illustrating the operation of the digital camera 1 according to the present embodiment.

FIG. 4A shows the imaging timing of the image sensor 110 of the digital camera 1 for each frame. FIG. 4B shows the drive timing of the imaging optical system 20. FIG. 4C shows the drive timing of the event optical system 30. FIG. 4D illustrates a timing of changing the event threshold of the event sensor 350. FIG. 4E illustrates an output timing of the event data of the event sensor 350. FIG. 4F illustrates a timing of generating the event image 50 based on the event data. FIG. 4G illustrates the input timing of the captured image 40 to be corrected. FIG. 4H illustrates the output timing of the corrected image 60.

In the digital camera 1 of the present embodiment, the camera controller 140 supplies a vertical synchronization signal to the image sensor 110 to control an imaging operation of the image sensor 110 for each frame, for example. For example, as illustrated in FIG. 4A, the image sensor 110 performs an imaging operation in an imaging frame period T1 corresponding to the imaging frame rate, and sequentially generates the captured image 40 (FIG. 3A) for each frame. The imaging operation of the image sensor 110 includes an exposure period of the captured image 40 and a readout period of the imaging data for each frame, for example.

In the digital camera 1 of the present embodiment, the event sensor 350 detects an event indicating a luminance change within the angle of view of the event sensor 350 during the imaging operation of the image sensor 110 as described above. For example, the event sensor 350 sequentially outputs event data indicating the detection result of the event to the camera controller 140, as illustrated in FIG. 4E. The operation cycle of the event sensor 350 is shorter than the various frame cycles T1 and T2.

For example, the camera controller 140 generates the event image 50 (FIG. 3B) based on the event data for each moving image frame period T2 corresponding to the moving image frame rate, as illustrated in FIG. 4F. For example, the camera controller 140 increments or decrements, for each event data, a pixel value at the position of the event indicated by the event data in an image region corresponding to the angle-of-view range of the event sensor 350. The camera controller 140 accumulates the event images 50 in the moving image frame period T2, to generate the event images 50 in the moving image frame period T2, for example.

In the digital camera 1 of the present embodiment, the camera controller 140 generates a moving image including the corrected image 60 (FIG. 3C) for each moving image frame period T2 based on the event image 50 and the captured image 40, for example, as illustrated in FIGS. 4F-4H. In the example of FIGS. 4A-4H, the synthesis processing of the corrected image 60 for the captured image 40 of the n-th frame is performed (FIGS. 4G and 4H) in the imaging operation of the (n+1)-th frame (FIG. 4A).

For example, the camera controller 140 performs image processing of stereo matching on each event image 50 so as to correct parallax with respect to the captured image 40. Further, the camera controller 140 detects the blurred portion 41 and the motion of the subject in the captured image 40 based on the luminance changed portion 51 of the event image 50 as the detection result of the event during the same period for each imaging frame period T1, for example. The camera controller 140 synthesizes the correction image 60 so as to correct the blur portion 41 in the captured image 40 for each moving image frame period T2 based on the detection result.

In this way, the digital camera 1 of the present embodiment can generate a moving image in which the imaging frame periods T1 are interpolated for each moving image frame period T2 by the corrected image 60 in which the motion blur of the subject in the captured image 40 is suppressed. The camera controller 140 records the generated moving image data in the memory card 171 via the card slot 170, for example.

In the above-described synthesis process of the corrected image 60, the corrected image 60 of each frame may be synthesized using not only each image 40, 50 of the corresponding frame but also each image 40, 50 in a predetermined range such as several frames before and after the corresponding frame. For example, the detection of the blurred portion 41 in the captured image 40 may be performed by image analysis of the captured image 40. The camera controller 140 may analyze an optical flow or calculate a motion vector for each moving image frame period T2 in the imaging frame period T1, based on the event image 50, for example. In addition, various image analysis techniques may be applied to the synthesis process of the corrected image 60, and for example, a machine learning model in which each image 40, 50 is input may be used.

### 2.2 Event Control Processing

The digital camera 1 of the present embodiment controls the event sensor 350 and the event optical system 30 in the moving image capturing operation as described above, to facilitate the synthesis of the corrected image 60 in which the motion blur of the subject is corrected, for example. The control process in the digital camera 1 of the present embodiment will be described with reference to FIGS. 4A- 4H and 5.

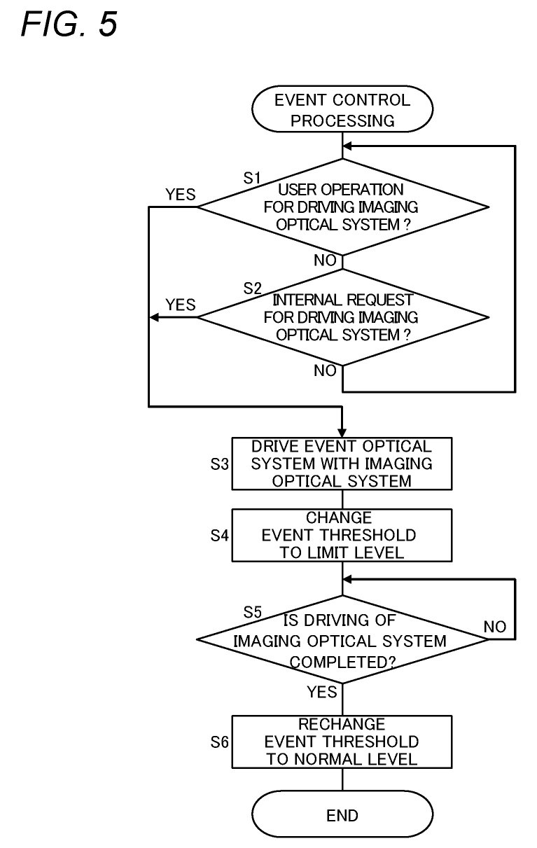

FIG. 5 is a flowchart illustrating an example of event control processing in the digital camera 1 of the present embodiment. Each process shown in the flow of FIG. 5 is executed by the camera controller 140 during the moving image capturing operation of the digital camera 1, for example.

First, the camera controller 140 detects various user operations on the digital camera 1, and determines whether an instruction to drive the imaging optical system 20 is input by the user operation (S1). For example, the user can input various user operations for changing the focus lens position, the zoom lens position, or the aperture value in the interchangeable lens 200 to the digital camera 1 by using various operation members 150, 212, 222 provided in the camera body 100 or the interchangeable lens 200.

For example, when the drive instruction of the imaging optical system 20 is not input by a user operation (NO in S1), the camera controller 140 determines whether or not the drive instruction of the imaging optical system 20 is input by various internal requests in the digital camera 1 (S2). For example, when the driving instruction of the imaging optical system 20 is not input by the internal request of the digital camera 1 (NO in S2), the camera controller 140 periodically repeats the processing after step S1.

For example, in the digital camera 1, when the focus lens position is changed by an AF (automatic focusing) operation or the aperture value or the like is changed by an AE (automatic exposure correction) operation, the determination of the step S2 becomes "YES". For example, according to an internal request of the digital camera 1, the digital camera 1 may be instructed to drive the imaging optical system 20 outside the exposure period of the image sensor 110.

When the drive instruction for the imaging optical system 20 is input by a user operation or an internal request (YES in S1 or S2), the camera controller 140 drives the imaging optical system 20 in accordance with the input drive instruction and drives the event optical system 30 in synchronization with the driving (S3).

In the example of FIG. 4B, the various drivers 210, 220, 260 of the imaging optical system 20 in the interchangeable lens 200 start the drive of the imaging optical system 20 from the time t1 by the drive instruction of the step S1 or S2, and completes the drive of the imaging optical system 20 at the time t2. In the digital camera 1 of the present embodiment, the drivers 311 to 331 of the event optical system 30 drive the event optical system 30 during the drive periods t1 to t2 of the imaging optical system 20, as illustrated in FIG. 4C, under the control (S3) of the camera controller 140.

For example, in step S3, the camera controller 140 calculates the driving amount of the event optical system 30 corresponding to the driving amount of the imaging optical system 20 based on the driving instruction (S1 or S2) of the imaging optical system 20. The driving amount of the event optical system 30 is calculated for each control parameter such as a focus lens position, a zoom lens position, and an aperture value so that various imaging states such as a focus position, an angle of view range, and a depth of field substantially match between the captured image 40 and the event image 50. An allowable error range may be appropriately set for the imaging state or the corresponding control parameter between the imaging optical system 20 and the event optical system 30.

Further, in the digital camera 1 of the present embodiment, the camera controller 140 changes the event threshold in the event sensor 350 from the normal level to a limit level (S4), as in an example shown in FIG. 4D. The processing of the step S4 is performed to limit the detection of the event by the event sensor 350 during the driving of each optical system 20, 30, for example.

The normal level of the event threshold is set as appropriate from the viewpoint of making it easy for the event sensor 350 to detect an event of a luminance change due to motion blur of the subject image with the event optical system 30 being not driven, for example. The limit level of the event threshold is set within a range higher than the normal level from the viewpoint of making it difficult for the event sensor 350 to detect, as an event, a luminance change due to driving of the event optical system 30, for example. The limit level may be set in advance as a predetermined value, or may be dynamically set according to the driving amount of each optical system 20, 30.

According to the process of step S4, the event sensor 350 does not detect, as an event, a luminance change that does not exceed the event threshold of the limit level raised from the normal level. In this way, the digital camera 1 of the present embodiment can suppress the output of the event data during the drive period t1 to t2 of each optical system 20, 30, for example, as illustrated in FIG. 4E.

The camera controller 140 determines whether the driving of the imaging optical system 20 is completed (S5). During the driving of the imaging optical system 20 (NO in S5), the event threshold is maintained at the limit level, for example. When the driving of the imaging optical system 20 is not completed (NO at S5), the camera controller 140 periodically performs determination of step S5, for example.

For example, when the driving of the imaging optical system 20 is completed (YES in S5), the camera controller 140 changes the event threshold again so as to return to the normal level (S6). Accordingly, the digital camera 1 of the present embodiment can restore the state in which the event sensor 350 can easily detect an event, e.g. after the time t2 in the example of FIG. 4A, and can accurately synthesize the corrected image 60.

For example, the camera controller 140 ends the event control processing shown in the flow of FIG. 5, after the re-change (S6) of the event threshold. Thereafter, while the moving image shooting is continued in the digital camera 1, the event control processing of FIG. 5 is repeatedly executed at a predetermined cycle such as the moving image frame cycle T2.

According to the event control processing described above, the digital camera 1 of the present embodiment drives the event optical system 30 in accordance with the driving of the imaging optical system 20 (S3), and changes the event threshold to the limit level during the driving period from t1 to t2 (S4). This can make the imaging states of the imaging optical system 20 and the event optical system 30 closer to each other, or make it difficult to detect a luminance change caused by the driving of each optical system 20, 30 as an event, thereby making it easy to obtain the accuracy of combining the corrected image 60.

### 2.3 Event Image Correction Processing

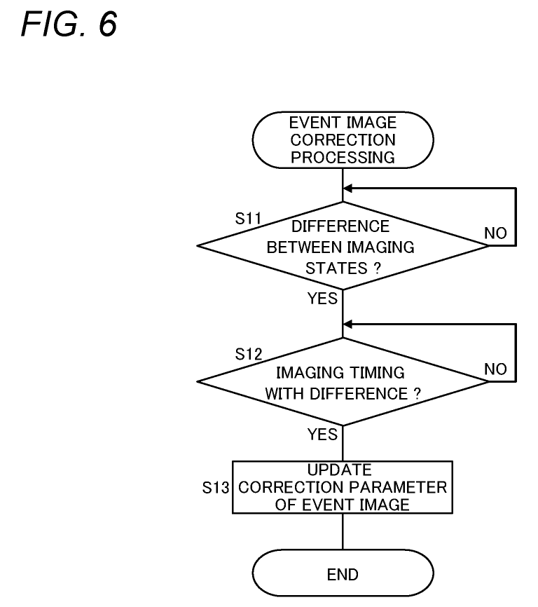

In the event control processing (FIG. 5) described above, when the imaging state of the imaging optical system 20 and the imaging state of the event optical system 30 cannot be completely matched, the digital camera 1 of the present embodiment may correct the influence of such a difference in the image processing of the event image 50. An example of such processing will be described with reference to FIG. 6.

FIG. 6 is a flowchart illustrating an example of the event image correction processing in the digital camera 1 of the present embodiment. The processing shown in FIG. 6 is executed by the camera controller 140 in parallel with the execution of the event control processing (FIG. 5), for example.

First, the camera controller 140 determines whether or not a difference occurs between the imaging state of the imaging optical system 20 and the imaging state of the event optical system 30, based on the drive instruction (S1 to S3) of each optical system 20, 30, for example (S11). For example, the determination of the step S11 can be performed by comparing control parameters updated by driving of the optical systems 20, 30 in synchronous driving (S3) of the optical systems 20, 30. When no difference between the imaging states of the optical systems 20, 30 (S11), the camera controller 140 periodically performs determination of step S11, for example.

When the difference occurs between the imaging states of the optical systems 20, 30 (YES in S11), the camera controller 140 detects whether or not the imaging timing of the frame in the imaging state having such a difference is reached (S12). For example, the imaging timing is a timing at which the event image 50 is generated for an event detected in a frame exposed by the image sensor 110 after the completion of the driving of the imaging optical system 20 (YES at S5). In the case where the imaging optical system 20 is driven over a plurality of imaging frame cycles T1, the step S12 may be performed for each frame.

For example, when the above-described imaging timing is not reached (NO at S12), the camera controller 140 periodically repeats the determination of step S12. For example, when the imaging timing is reached (YES in S12), the camera controller 140 updates the correction parameter of the event image 50 (S13). The correction parameter is a parameter for performing image processing of correcting the event image 50, and includes a magnification of electronic zoom, for example.

For example, after the update (S13) of the correction parameter, the camera controller 140 performs image processing in which the correction parameter is applied to the event image 50, and then performs the synthesis processing of the corrected image 60. For example, the camera controller 140 sets the electronic zoom magnification of the event image 50 (S13) so that the angle-of-view range of the event image 50 matches the angle-of-view range of the captured image 40 after the imaging optical system 20 is driven, and performs the electronic zoom process on the subsequent event image 50.

The camera controller 140 ends the process illustrated in FIG. 6 by updating (S13) the correction parameter. Thereafter, the camera controller 140 repeatedly executes the processing of FIG. 6, for example, periodically.

According to the above processing, even if a difference in the imaging state occurs between the imaging optical system 20 and the event optical system 30 (YES in S11), the digital camera 1 of the present embodiment can correct the event image 50 so as to reduce the difference between the captured image 40 and the event image 50 (S13). Accordingly, the digital camera 1 of the present embodiment can facilitate synthesizing the corrected image 60 using the event sensor 350.

### 3. Review

As described above, the digital camera 1 or the camera body 100 as an example of the imaging apparatus according to the present exemplary embodiment includes the image sensor 110 as an example of the image sensor, the event sensor 350 as an example of the detector, and the camera controller 140 as an example of the controller. The image sensor 110 captures a subject image at an imaging frame period T1, which is an example of a first period, via the imaging optical system 20, which is an example of a first optical system, and generates image sensing data. The event sensor 350 outputs event data, which is an example of detection data indicating a detection result of a change in the subject image, in an operation cycle, which is an example of a second cycle shorter than the first cycle, via the event optical system 30, which is an example of a second optical system. The camera controller 140 controls an image capturing operation using the image sensor 110 and the event sensor 350. The camera controller 140 restricts the output of the event sensor 350 when the second optical system is driven during the image capturing operation (S4 to S6).

According to the imaging apparatus described above, in the capturing of the corrected image 60 using a plurality of sensors such as the image sensor 110 and the event sensor 350, the detection of the event is suppressed, for example, during the driving of the event optical system 30. This can facilitate capturing the corrected image 60 in which the blurred portion 41 and the like of the captured image 40 are corrected by the event image 50 using the sensors 110, 350.

In the present embodiment, the imaging optical system 20 and the event optical system 30 are configured separately from each other. The camera controller 140 drives the event optical system 30 when the imaging optical system 20 is driven in accordance with the instruction to drive the imaging optical system 20 (S3). Accordingly, by driving the event optical system 30 during the driving of the imaging optical system 20, it is possible to easily capture the corrected image 60 using the sensors 110, 350.

In the present embodiment, the camera controller 140 drives the event optical system 30 so as to bring the imaging state of the event optical system 30 close to the imaging state of at least one of the focus position, the angle of view range, and the depth of field in the imaging optical system 20 (S4). This makes it easy to perform stereo matching between the captured image 40 and the event image 50 in the synthesis of the corrected image 60, for example, and makes it easy to synthesize the corrected image 60.

In the present embodiment, the camera controller 140 may adjust the parameters of the image processing using the event data based on the differences between the imaging state of the imaging optical system 20 and the imaging state of the event optical system 30, and generate the image data of the corrected image 60 (S11 to S13). Accordingly, when a difference is present between the imaging state of the imaging optical system 20 and the imaging state of the event optical system 30, the correction parameters of the image processing are adjusted, and the corrected image 60 can be easily synthesized.

In the present embodiment, the camera controller 140 performs image processing such as a process of combining the corrected images 60 based on the imaging data generated by the image sensor 110 and the event data output from the event sensor 350, and generates image data such as moving image data. The camera controller 140 limits the output of the event sensor 350 when the second optical system is driven (S4 to S6), and performs the image processing to generate the corrected image 60. Accordingly, the digital camera 1 of the present embodiment can perform the synthesis processing of the corrected image 60 during the image capturing operation, and can capture and record the corrected image 60 in real time, for example. The digital camera 1 may perform the synthesis processing of the corrected image 60 not only in real time but also after the image capturing operation.

In the present embodiment, the camera controller 140 generates the image data of the corrected image 60 so as to correct the motion blur of the subject image in the imaging data such as the blur portion 41 in the captured image 40 based on the event data. According to the digital camera 1 of the present embodiment, it is possible to easily correct the motion blur of the subject using each sensor 110, 350. The image data of the corrected image 60 may constitute a moving image including frame images in a frame period shorter than the first period. The digital camera 1 of the present embodiment can easily generate moving image data of the corrected image 60 by such frame interpolation.

In the present embodiment, the imaging optical system 20 constitutes an interchangeable lens 200 that is attachable to and detachable from the imaging apparatus. The detector is an event sensor 350 that detects a change in the subject image via the event optical system 30 and generates event data. Accordingly, the event sensor 350 is provided in the digital camera 1 of the lens interchangeable type, and thus it is possible to easily perform the photographing of the correction image 60 using the plurality of sensors 110, 350. The digital camera 1 of the present embodiment may further include an event optical system 30.

### Second Embodiment

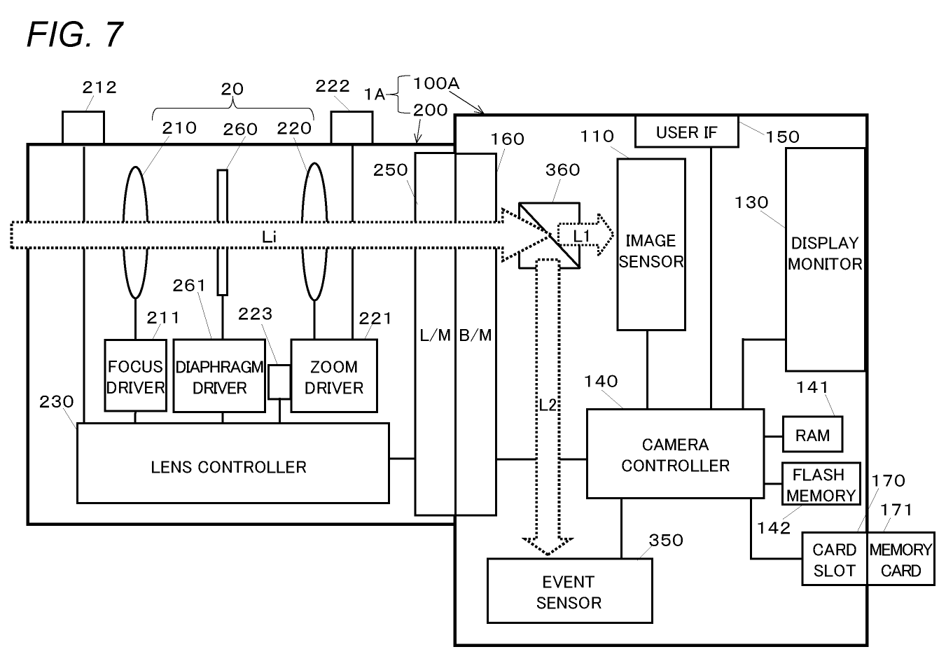

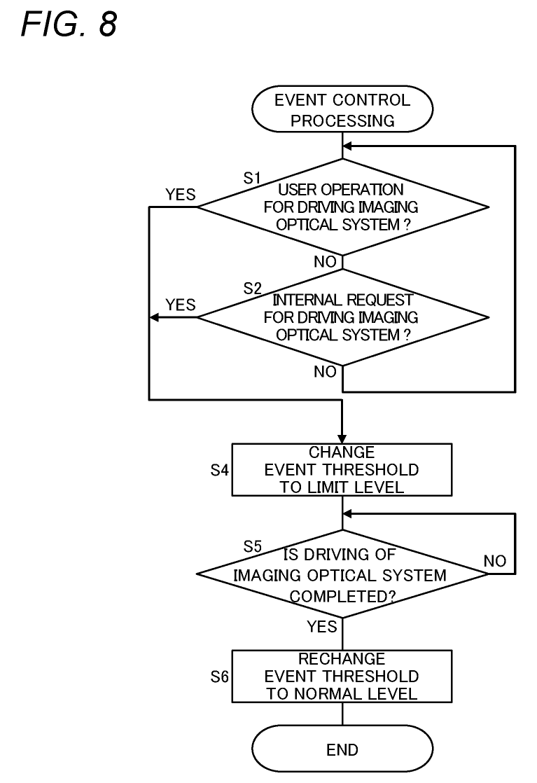

Hereinafter, a second embodiment of the present disclosure will be described with reference to FIGS. 7 and 8. In the first embodiment, the digital camera 1 in which the imaging optical system 20 and the event optical system 30 are separately configured has been described. In the second embodiment, a digital camera 1A in which the imaging optical system 20 and the event optical system 30 are integrally configured will be described.

Hereinafter, the digital camera 1A according to the present embodiment will be described, omitting the description of the same configuration and operation as the digital camera 1 according to the first embodiment as appropriate.

FIG. 7 shows a configuration of the digital camera 1A according to the second embodiment. The digital camera 1A of the present embodiment does not include the event optical system 30 and the drivers 311 to 331 thereof in the same configuration as the digital camera 1 of the first embodiment (see FIG. 1), and instead includes a light splitter 360 as illustrated in FIG. 7, for example. Accordingly, the digital camera 1A of the present embodiment shares the imaging optical system 20 of the interchangeable lens 200 as an event optical system, for example.

In the digital camera 1A of the present embodiment, the light splitter 360 is provided on the 100A of the camera body, for example. The light splitter 360 is an optical element such as a half mirror or a beam splitter. The light splitter 360 is disposed so as to separate the incident light Li incident from the interchangeable lens 200 into first and second incident light L1 and L2 by transmission or reflection, and to cause the first incident light L1 to be incident on the image sensor 110 and the second incident light L2 to be incident on the event sensor 350, for example.

FIG. 8 is a flowchart illustrating an example of event control processing in the digital camera 1A according to the second exemplary embodiment. The digital camera 1A of the present embodiment synthesizes the corrected image 60 based on the captured image 40 of the image sensor 110 and the event image 50 of the event sensor 350 similarly to the first embodiment, for example.

In the event control processing (FIG. 5) of the first embodiment, the camera controller 140 drives the event optical system 30 in synchronization with the imaging optical system 20 (S3). In the event control processing in the digital camera 1A of the present embodiment, the camera controller 140 performs the processing of steps S3 to S6 similar to that of the first embodiment without performing the processing of step S1, as illustrated in FIG. 8, for example. The digital camera 1A of the present embodiment may perform the event image correction processing (FIG. 6) similar to that of the first embodiment.

As described above, in the digital camera 1A of the present embodiment, the first optical system and the second optical system are configured by the imaging optical system 20 and the light splitter 360, which are common optical systems. The digital camera 1A or the camera body 100A as an example of the imaging apparatus of the present embodiment further includes the light splitter 360 that separates the incident light Li incident on the imaging optical system 20 into the first incident light L1 and the second incident light L2, guides the first incident light L1 to the image sensor 110, and guides the second incident light L2 to the event sensor 350. According to the imaging apparatus of the present embodiment, similarly to the imaging apparatus of the first embodiment, it is possible to easily perform image capturing of the corrected image 60 using the plurality of sensors 110, 350.

### Other Embodiments

As described above, the first and second embodiments have been described as examples of the technique disclosed in the present application. However, the technique in the present disclosure is not limited to this, and is applicable to embodiments in which changes, replacements, additions, omissions, and the like are made as appropriate. In addition, it is also possible to combine the respective constituent elements described in the above respective embodiments to form a new embodiment. Therefore, other embodiments will be exemplified below.

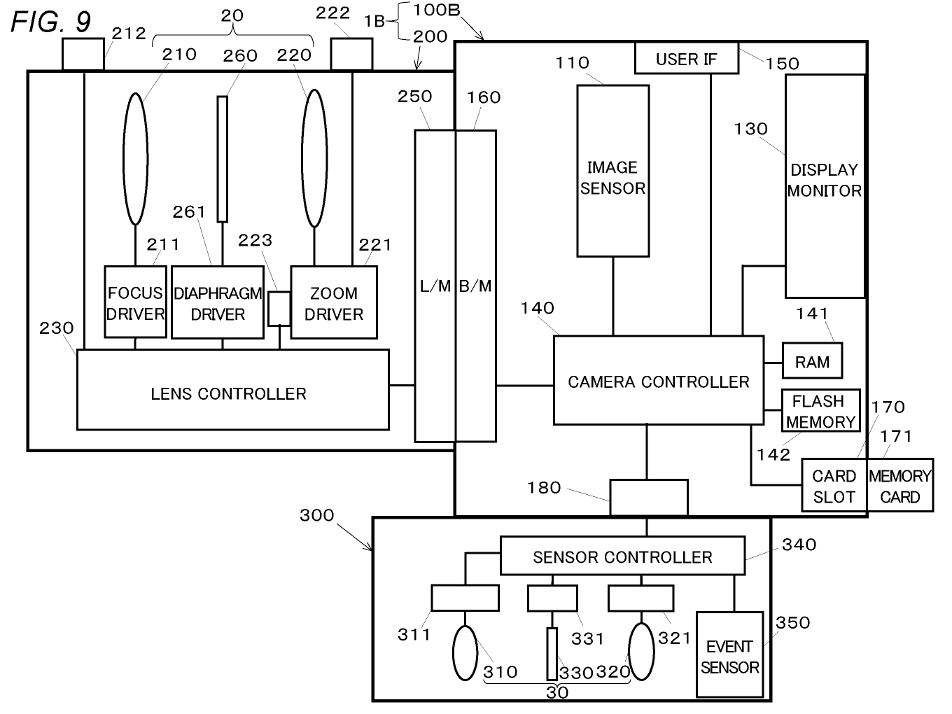

In the first embodiment described above, the digital camera 1 including the event sensor 350 in the camera body 100 has been described. The present disclosure is not limited to this, and the event sensor 350 having an external configuration of the digital camera may be used. Such a modification will be described with reference to FIG. 9.

FIG. 9 illustrates a configuration of a digital camera 1B of the present modification. In the present embodiment, the digital camera 1B may further include a communication interface 180 that can communicate with the event detection device 300 of an external configuration. For example, the event detection device 300 is mounted on the upper portion of the 100B of the camera body. The communication interface 180 is an accessory shoe such as a hot shoe to which an external accessory such as the event detection device 300 can be detachably attached. The communication interface 180 may be various connection circuits conforming to a predetermined communication standard such as USB.

For example, the event detection device 300 is an external accessory of a digital camera 1B, and includes an event sensor 350, an event optical system 30, various drivers 311 to 331, and a sensor controller 340. The sensor controller 340 controls the overall operation of the event detection device 300. The sensor controller 340 may be configured by a hard-wired electronic circuit, or may be configured by a microcomputer that executes a program, or the like. The lens controller 230 may include a RAM, a ROM, a flash memory, or the like. The sensor controller 340 may include an interface circuit capable of data communication with an external device.

In the present embodiment, when the event sensor 350 generates an event, the event detection device 300 transmits the event to the communication interface 180 of the digital camera 1B via the sensor controller 340. In the digital camera 1B, when the communication interface 180 receives the event data from the event detection device 300, the communication interface 180 outputs the received event data to the camera controller 140. The communication interface 180 is an example of a detector in the present embodiment.

The digital camera 1B of the present embodiment can perform an operation of capturing a moving image or the like using the event sensor 350, similarly to the digital camera 1 of the first embodiment, by communicating with the event detection device 300 via the communication interface 180. The camera controller 140 of the present embodiment controls the event sensor 340 and the drivers 311 to 331 of the event optical system 30 via the communication interface 180, and can perform the same event control processing (FIG. 5) as that of the first embodiment, for example.

As described above, in the digital camera 1B and the camera body 100B of the present embodiment, the imaging optical system 20 constitutes the interchangeable lens 200 that is attachable to and detachable from the imaging apparatus. The detector is the communication interface 180 that receives detection data from the event sensor 350 that generates the detection data by detecting a change in the subject image via the event optical system 30. According to such an imaging apparatus, similarly to the above-described imaging apparatuses, it is possible to easily perform image capturing of the corrected image 60 using the plurality of sensors 110, 350.

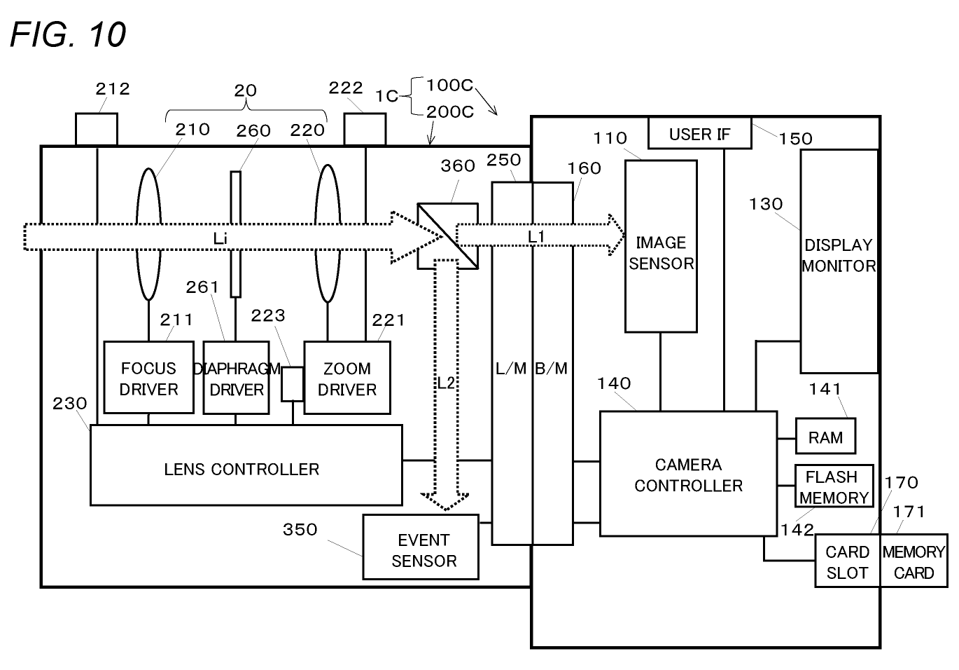

In the second embodiment, the digital camera 100A in which the camera body 1A includes the light splitter 360 has been described. Such a modification will be described with reference to FIG. 10.

FIG. 10 illustrates a configuration of a digital camera 1C of the present modification. For example, the digital camera 1C of the present embodiment may be configured in the same manner as in the second embodiment, and as shown in FIG. 10, the light splitter 360 may be provided in the interchangeable lens 200C in place of in the camera body 100C. Alternatively, the digital camera 1C of the present embodiment may include the light splitter 360 in an adapter that can be inserted between the camera body 100C and the interchangeable lens 200. The event sensor 350 of the present embodiment is provided in a device including the light splitter 360, for example.

As described above, in the digital camera 1C according to the present exemplary embodiment, the light splitter 360 in the common optical system for the sensors 110, 350 may be provided outside the camera body 100. Even in the digital camera 1C of the present embodiment, it is possible to easily perform image capturing using the plurality of sensors 110, 350, similarly to the digital camera 1A of the second embodiment, for example.

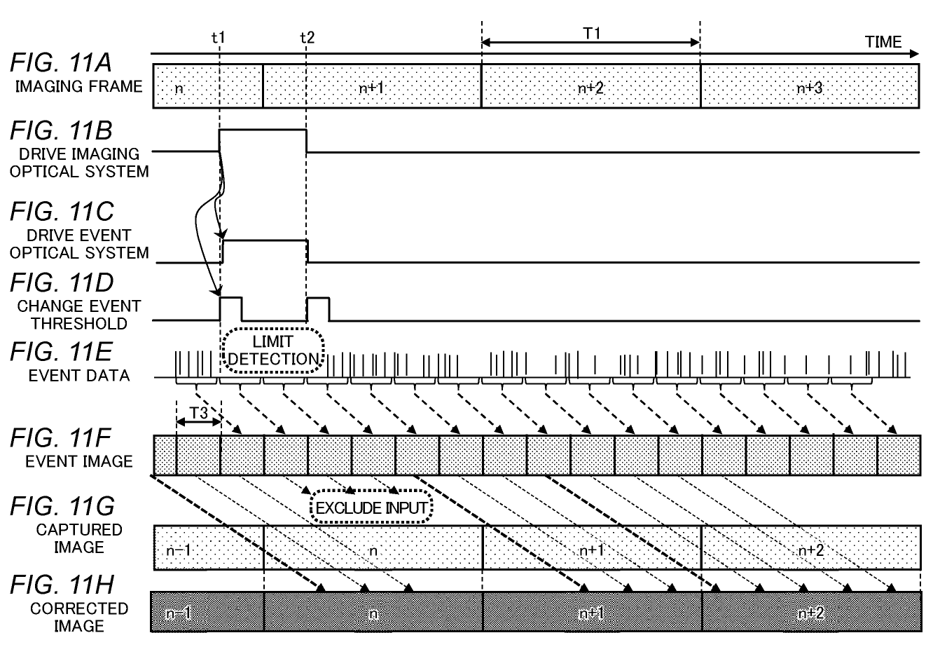

In the above embodiments, an operation example in which the digital camera 1 performs moving image shooting has been described, but the present disclosure is not particularly limited to moving image capturing. The present disclosure may be applied to still image shooting, and may be applied to continuous shooting, for example. Such a modification will be described with reference to FIGS. 11A-11H.

FIGS. 11A-11H are timing charts illustrating a continuous shooting operation of the digital camera 1 in the present modification. FIGS. 11A-11H illustrate the timing of various signals in the digital camera 1, similarly to FIGS. 4A-4H.

In the present embodiment, the digital camera 1 performs an imaging operation of the image sensor 110 in an imaging frame cycle T1 as a cycle of continuous shooting, to generate a captured image 40 for each frame, for example (FIG. 11A). At this time, the event sensor 350 sequentially detects events and generates event data (FIG. 11E), for example, as in the first embodiment. The camera controller 140 generates the event image 50 as in the first embodiment based on the event data for each correction cycle T1 shorter than the imaging frame cycle T3, for example (FIG. 11F). The camera controller 140 synthesizes the corrected image 60 so as to correct the blurred portion 41 of the captured image 40 based on the event image 50 (FIGS. 11F-11H). For example, the camera controller 140 sequentially records the synthesized correction image 60 as still image data in the memory card 171.

In the continuous shooting operation as described above, the digital camera 1 of the present embodiment performs the event control processing (FIG. 5) as in the first embodiment, to control the event sensor 350 and the event optical system 30, for example. Accordingly, the digital camera 1 of the present embodiment can easily perform the synthesis of the corrected image 60 using the event data even during the continuous shooting.

In the present embodiment, the camera controller 140 may select the event image 50 to be used for the synthesis of the corrected image 60 from among the plurality of event images 50 for the imaging frame period T1, for example. For example, as illustrated in FIGS. 11F-11H, the camera controller 140 of the present embodiment may exclude the event image 50 including the detection result of the event during the driving of each optical system 20, 30 from the event image 50 used for the synthesis of the corrected image 60. This makes it easy to avoid a situation in which a luminance change due to the influence of the driving of each optical system 20, 30 affects the corrected image 60.

In the above embodiments, the digital camera 1 that limits the output of the event sensor by changing the event threshold (from S4 to S6) has been described. The digital camera 1 of the present embodiment may set a disabled period in which the output of the event sensor 350 is not used, instead of changing the event threshold (from S4 to S6) during the driving of the event optical system 30, for example.

In the disabled period as described above, the camera controller 140 may change the algorithm of the synthesis processing of the corrected image 60 to an algorithm different from that in the period other than the disabled period. For example, the camera controller 140 may calculate the motion vector by referring to the captured images 40 of the previous and subsequent frames instead of the event image 50. The digital camera 1 of the present embodiment can perform the synthesis processing of the corrected image 60 by limiting the output of the event sensor 350 during the driving of each optical system 20, 30 even by setting the disabled period of the event sensor 350.

In the above embodiments, the digital camera 1 that generates the event image 50 intermediately for the synthesis of the corrected image 60 has been described. In the present embodiment, the digital camera 1 may not necessarily generate the event image 50 intermediately, and may execute image processing similar to the above-described processing based on the corresponding event data instead of the event image 50.

In the embodiments described above, the digital camera 1 that performs synchronous driving of the imaging optical system 20 and the event optical system 30 has been described, but the present disclosure is not limited thereto. The digital camera 1 of the present embodiment may perform the synthesis processing of the corrected image 60 by limiting the output of the event sensor 350 during the driving of the event optical system 30, for example, without performing the synchronous driving of the imaging optical system 20 and the event optical system 30. This also makes it possible to accurately combine the corrected images 60, as in the above embodiments.

In the embodiments described above, the digital camera 1 that performs the synthesis process of the corrected image 60 by limiting the output of the event sensor 350 has been described, but the present disclosure is not limited thereto. The digital camera 1 of the present embodiment may perform synchronous driving of the imaging optical system 20 and the event optical system 30 without limiting the output of the event sensor 350 during driving of each optical system 20, 30, for example. This also makes it possible to accurately combine the corrected images 60, as in the above embodiments.

That is, the imaging apparatus of the present embodiment includes the image sensor 110 that captures a subject image at a first cycle via the imaging optical system 20 to generate imaging data, the event sensor 350 that outputs event data indicating a detection result of a change in the subject image at a second cycle shorter than the first cycle via the event optical system 30 configured separately from the imaging optical system 20, and the camera controller 140 that performs image processing based on the imaging data generated by the image sensor 110 and the event data output from the event sensor 350 and generates image data. The camera controller 140 drives the event optical system 30 when the imaging optical system 20 is driven in accordance with the instruction to drive the imaging optical system 20. With such an imaging apparatus, it can facilitate performing image capturing using the plurality of sensors 110, 350, as in the above-described embodiments.

In the above embodiments, the digital camera 1 has been described which synthesizes the corrected image 60 so as to correct the motion blur of the subject such as the blur portion 41 of the captured image 40 using the event sensor 350. The digital camera 1 of the present embodiment may correct not only the motion blur of the subject but also various blurs in the captured image 40. For example, the camera controller 140 of the present embodiment may combine the correction image 60 with the blur of the captured image 40 due to the camera shake of the digital camera 1 using the detection result of the event by the event sensor 35.

In the embodiments described above, an operation example in which the synthesis processing of the corrected image 60 is performed inside the digital camera 1 has been described, but such image processing may be performed outside the digital camera 1. For example, in the digital camera 1 of the present embodiment, the camera controller 140 may manage tag information (e.g., a time stamp) that associates the captured image 40 by the image sensor 110 with the event image 50 by the event sensor 350, and perform the image capturing operation. For example, the camera controller 140 may record the data of each image 40, 50 and the tag information in the memory card 171, and the PC or the like may perform the synthesis processing of the corrected image 60 based on the information recorded in the memory card 171 after the image is captured. This also makes it easy for the digital camera 1 of the present embodiment to perform image capturing using the sensors 110, 350, as in the above embodiments.

In the above embodiments, the digital camera 1 using the event sensor 350 has been described. The digital camera 1 of the present embodiment is not limited to this, and for example, a sensor that generates the event image 50 as detection data may be used instead of the event sensor 350.

In the above embodiments, the lens interchangeable digital camera has been described as an example of the imaging apparatus, but the imaging apparatus of the present embodiment may be a digital camera that is not particularly a lens interchangeable type. The concept of the present disclosure is applicable not only to a digital camera but also to a movie camera and an electronic apparatus having various imaging functions.

### Aspect Example

Various aspects according to the present disclosure will be listed below.

A first aspect according to the present disclosure is an imaging apparatus including: an image sensor that captures a subject image at a first cycle via a first optical system to generate imaging data; a detector that outputs detection data via a second optical system, the detection data indicating a detection result of a change in the subject image at a second cycle shorter than the first cycle; and a controller that controls an image capturing operation using the image sensor and the detector, wherein the controller limits an output of the detection data by the detector when the second optical system is driven in the image capturing operation.

According to a second aspect, in the imaging apparatus according to the first aspect, the first optical system and the second optical system are configured separately from each other, and the controller drives the second optical system when the first optical system is driven in accordance with an instruction to drive the first optical system.

According to a third aspect, in the imaging apparatus according to the second aspect, the controller drives the second optical system to cause an imaging state of the second optical system to approach an imaging state of the first optical system, each imaging state including at least one of a focus position, an angle of view range, or a depth of field in a corresponding optical system.

According to a fourth aspect, in the imaging apparatus according to the third aspect, the controller adjusts a parameter of image processing using the detection data, based on a difference between the imaging state of the first optical system and the imaging state of the second optical system.

According to a fifth aspect, in the imaging apparatus according to any one of the first to fourth aspects, the controller performs image processing based on the imaging data generated by the image sensor and the detection data output from the detector, to generate image data. When the second optical system is driven, the controller performs the image processing with limiting the output of the detection data by the detector, to generate the image data.

According to a sixth aspect, in the imaging apparatus according to the fifth aspect, the controller generates the image data to correct a motion blur of the subject image in the imaging data, based on the detection data.

According to a seventh aspect, in the imaging apparatus according to any one of the first to sixth aspects, the first optical system is included in an interchangeable lens that is detachably attachable to the imaging apparatus, and the detector is an event sensor that detects a change in the subject image via the second optical system to generate the detection data.

According to an eighth aspect, in the imaging apparatus according to any one of the first to sixth aspects, the first optical system is included in an interchangeable lens that is detachably attachable to the imaging apparatus, and the detector is a communication interface that receives the detection data from an event sensor that detects a change in the subject image via the second optical system to generate the detection data.

According to a ninth aspect, in the imaging apparatus according to the first to sixth aspects, the first optical system and the second optical system are configured as a common optical system, and the common optical system includes a light splitter that splits incident light into first incident light and second incident light, to guide the first incident light into the image sensor, and guide the second incident light into the detector.

A tenth aspect is an imaging apparatus including: an image sensor that captures a subject image at a first cycle via a first optical system to generate imaging data; a detector that outputs detection data via a second optical system configured separately from the first optical system, the detection data indicating a detection result of a change in the subject image at a second period shorter than the first period; a controller that controls an image capturing operation using the image sensor and the detector, wherein the controller drives the second optical system when the first optical system is driven in accordance with an instruction to drive the first optical system.

As described above, the exemplary embodiments have been described as examples of the technique in the present disclosure. For this purpose, the accompanying drawings and the detailed description are provided.

Therefore, the components described in the accompanying drawings and the detailed description may include not only components essential for solving the problem but also components not essential for solving the problem in order to illustrate the above technique. Therefore, it should not be immediately recognized that the non-essential components are essential because the non-essential components are described in the accompanying drawings and the detailed description.

In addition, since the above-described exemplary embodiments are intended to illustrate the technique in the present disclosure, various changes, substitutions, additions, omissions, and the like can be made within the scope of the claims or the scope of equivalents thereof.

The present disclosure is applicable to various imaging apparatuses that use a plurality of sensors for image capturing.

1. An imaging apparatus comprising:
an image sensor that captures a subject image at a first cycle via a first optical system to generate imaging data;
a detector that outputs detection data via a second optical system, the detection data indicating a detection result of a change in the subject image at a second cycle shorter than the first cycle; and
a controller that controls an image capturing operation using the image sensor and the detector, wherein
the controller limits an output of the detection data by the detector when the second optical system is driven in the image capturing operation.

2. The imaging apparatus according to claim 1, wherein
the first optical system and the second optical system are configured separately from each other, and
the controller drives the second optical system when the first optical system is driven in accordance with an instruction to drive the first optical system.

3. The imaging apparatus according to claim 2, wherein
the controller drives the second optical system to cause an imaging state of the second optical system to approach an imaging state of the first optical system, each imaging state including at least one of a focus position, an angle of view range, or a depth of field in a corresponding optical system.

4. The imaging apparatus according to claim 3, wherein
the controller adjusts a parameter of image processing using the detection data, based on a difference between the imaging state of the first optical system and the imaging state of the second optical system.

5. The imaging apparatus according to claim 1, wherein
the controller performs image processing based on the imaging data generated by the image sensor and the detection data output from the detector, to generate image data, and
when the second optical system is driven, the controller performs the image processing with limiting the output of the detection data by the detector, to generate the image data.

6. The imaging apparatus according to claim 5, wherein
the controller generates the image data to correct a motion blur of the subject image in the imaging data, based on the detection data.

7. The imaging apparatus according to claim 1, wherein
the first optical system constitutes part of an interchangeable lens that is detachably attachable to the imaging apparatus, and
the detector is an event sensor that detects a change in the subject image via the second optical system to generate the detection data.

8. The imaging apparatus according to claim 1, wherein
the first optical system constitutes part of an interchangeable lens that is detachably attachable to the imaging apparatus, and
the detector is a communication interface that receives the detection data from an event sensor that detects a change in the subject image via the second optical system to generate the detection data.

9. The imaging apparatus according to claim 1, wherein
the first optical system and the second optical system are configured as a common optical system, and
the common optical system includes a light splitter that splits incident light into first incident light and second incident light, to guide the first incident light into the image sensor, and guide the second incident light into the detector.

10. An imaging apparatus comprising:
an image sensor that captures a subject image at a first cycle via a first optical system to generate imaging data;
a detector that outputs detection data via a second optical system configured separately from the first optical system, the detection data indicating a detection result of a change in the subject image at a second period shorter than the first period;
a controller that controls an image capturing operation using the image sensor and the detector, wherein
the controller drives the second optical system when the first optical system is driven in accordance with an instruction to drive the first optical system.
